(19) United States
(12) Patent Application Publication
(10) Pub. No.: US 2012/0037083 A1
(43) Pub. Date: Feb. 16, 2012

(54) Pet Kennel

(76) Inventor: Arthur Lewis Greene, Cutler Bay, FL (US)

(21) Appl. No.: 12/853,617

(22) Filed: Aug. 10, 2010

(51) Int. Cl. A01K 1/00

(52) U.S. Cl. 119/497

(57) ABSTRACT

A pet kennel having a lower compartment with a bottom, a rear wall, a front wall and two side walls, and an upper compartment having a fixed section and a swingable section. The fixed section of the upper compartment is removably attached to the lower compartment, and the swingable section is removably attached to the lower compartment and swingably attached to the fixed section. Access to the pet kennel is provided when the swingable section is swung to an open position.

### BACKGROUND OF THE INVENTION

1. Field of the Invention

The present invention relates generally to a pet kennel and more specifically to a pet kennel having a lower compartment and an upper compartment where the upper compartment has a fixed section which is normally removably attached to the lower compartment with catches and a swingable kennel access section which is permanently pivotally attached to the fixed section of the upper compartment and removably attached to the lower compartment with catches.

2. Description of Related Art

Pet kennels for holding pets while traveling are known in the prior art. More specifically, by way of example, U.S. Pat. No. 6,571,740 to Kinder, et al. discloses a kennel that can be placed between a use position, where an enclosure is formed to house an animal, and a nested position, where the kennel is reconfigured to provide a compact structure for storage. The kennel contains an upper portion and lower portion with the upper portion containing a lip so as to mate with a rim on the lower portion. In the assembled position, the lower portion rim supports the upper portion to form an interior for holding a small animal. When in the nested position, the lower portion rim and the upper portion lip are detached and the lower portion is re-configured and housed inside the upper portion.

U.S. Pat. No. 6,427,631 to Ross discloses a door for a kennel having a disc and bars. The bars extend across the door and secures the door to the first end in a closed position. The disc enables the bars to move, i.e., retract and extend, to open and close the door. Carrier ends of the bars are received in receptacles located in the first end and disc ends of the bars are received in the disc.

U.S. Pat. No. 6,308,661 to Burns, et al. discloses a pet carrier for transporting pets within the passenger compartments of aircraft which includes closeable windows of mesh fabric, an openable end and a side for providing access to the interior of the pet carrier, and an access port in the top having a full length double zipper closure and a rotatable locking member for securing the access port in the closed condition.

U.S. Pat. No. 6,182,611 to Marchioro discloses a container for carrying pets which has a hollow body with a closeable access provided with an opening which is blocked by a grille which is fixed to the rim of the opening with rivets.

U.S. Pat. No. 5,701,843 to Lazides discloses a pet carrier for a large animal. The carrier has a handle which can be folded to conserve space and retractable wheels which can be placed in a down position when moving the carrier with the pet inside, or can be placed in an up or inactive position when mobility is not necessary or when it is desired to maintain the carrier in a stationary position.

U.S. Pat. No. 5,357,900 to Ho discloses a cage includes a base with an opening, two accesses and a cover having an opening and two accesses aligned with the opening and the accesses of the base. The cage includes a pan disposed in the bottom portion for collecting discharges of pets.

### SUMMARY OF THE INVENTION

In an exemplary embodiment of the present invention, there is disclosed a pet kennel having a lower compartment with a bottom, a rear wall, a front wall and two side walls, and an upper compartment having a fixed section and a swingable section. The fixed section of the upper compartment is removably attached to the lower compartment, and the swingable section is removably attached to the lower compartment and swingably attached to the fixed section. Access to the pet kennel is provided when the swingable section is swung to an open position or through a door located opposite the swingable section of the pet kennel. A pad or strip of high friction material such as rubber is attached to the bottom of the kennel to prevent it from sliding when trying to place a difficult or reluctant dog into the kennel.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of a pet kennel having a swinging front access section which is in its closed position;

FIG. 2 is a front elevational view of the pet kennel with the swinging front access section in its closed position;

FIG. 3 is a right side view of the pet kennel with the swinging front access section partially open; and

FIG. 4 is a view of the bottom of the pet kennel.

### DESCRIPTION OF THE PREFERRED EMBODIMENT

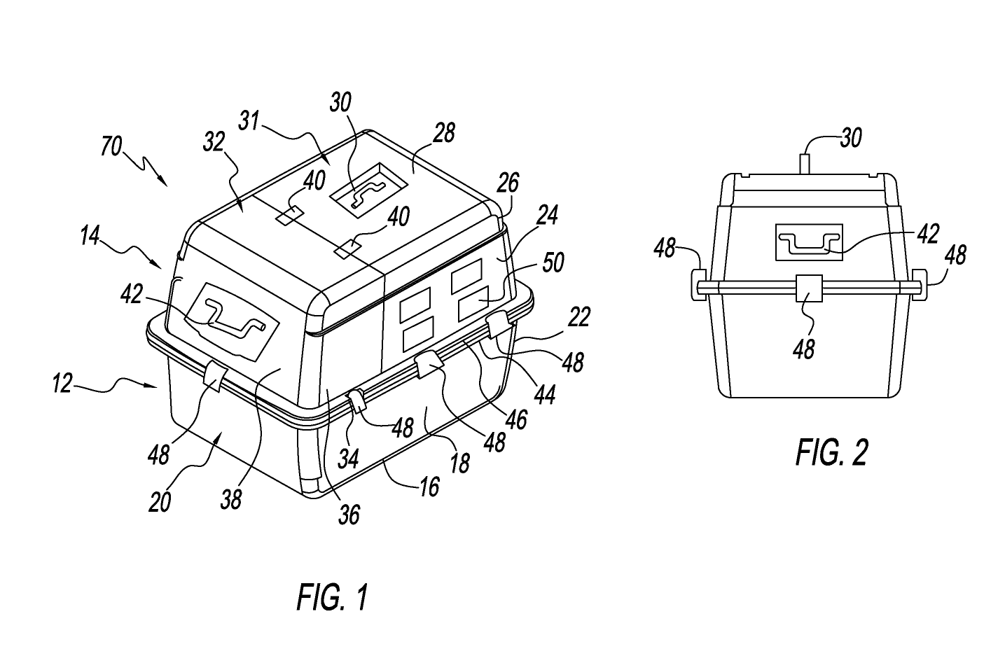

Referring to FIG. 1, there is disclosed a perspective view of a pet kennel having a swinging front access section where the front access is in a closed position. The pet kennel 10 has a lower compartment 12 and an upper compartment 14 for holding a pet.

The lower compartment 12 has a bottom 16, two side walls 18, a front wall 20 and a rear wall 22. The front and rear walls are attached to each other and to the bottom 16 with generous radii. The lower compartment has a generally rectangular cross sectional length, a generally rectangular cross sectional width, and a depth that can be between five and nine inches. The lower compartment can be made of a rigid or semi-rigid plastic such as, for example PVC. It is understood that the lower compartment is not limited to PVC but other material or other plastic may be used in making the lower compartment.

The upper compartment 14 consists of a fixed section 31 which is normally removably attached to the lower section and a swingable section 32 which is rotatably attached to the fixed section and removably attached to the lower section.

The fixed section of the upper compartment has two partial side walls 24, a rear wall 26, a partial top 28 having a fold down carrying handle 30 and a swingable section 32 which is a unitary member having a partial top 34, two partial side walls 36 and a front wall 38. The fold down carrying handle 30 may be located in a recess to be flush with the surface of the partial top 28 when folded down and not in use.

Vent openings 50 which may be one inch by two inches are located on the partial side walls 24 and the rear wall 26 of the upper compartment 26 to allow air to enter and leave the pet kennel

The partial top 34 of the swingable section is pivotally attached to the partial top 28 of the fixed section with two hinges 40 and includes a fold down handle 42 which is pivotally attached to the front wall 38. Handle 42 is provided for use when the swingable access section is being opened or closed and may be recessed to be below the surface of the front wall 38.

A flange 44 which encircles the perimeter of the lower compartment 12 mates with a flange 46 which encircles the perimeter of the upper compartment 14. Swing or slide quick release catches 48 are attached to the front wall, rear and side walls, or to flanges 44, 46 removably lock the upper compartment 14 to the lower compartment 12. More specifically, there can be three quick release catches 48 along the flange on each side of the pet kennel and one quick release catch along the flange on the front and rear walls.

Swingable access section 32 has a width that is equal to the width of the upper compartment and extends back along the pet kennel for a distance of between eight inches and fifteen inches

The upper compartment 14 which includes the partial top swingable access section 32 and the partial top fixed section 31 has a generally rectangular cross sectional length, a generally rectangular cross sectional width, and a height that can be between nine inches and fourteen inches. The upper compartment can be made of a rigid or semi-rigid plastic such as, for example PVC. It is understood that the upper compartment is not limited to PVC but other material or other plastic may be used in making the upper compartment.

Referring to FIG. 2, there is shown a front elevational view of the pet kennel 10 with the swinging front access section 32 in a closed position and, together with the fixed section 31, the swinging front access section is locked to the lower compartment 12 by means of swing or slide quick release catches 48. Located at the opposite end of the pet kennel is a door that opens and closes (not shown) and which can be in the upper or lower compartment for placing or removing a pet from the pet kennel.

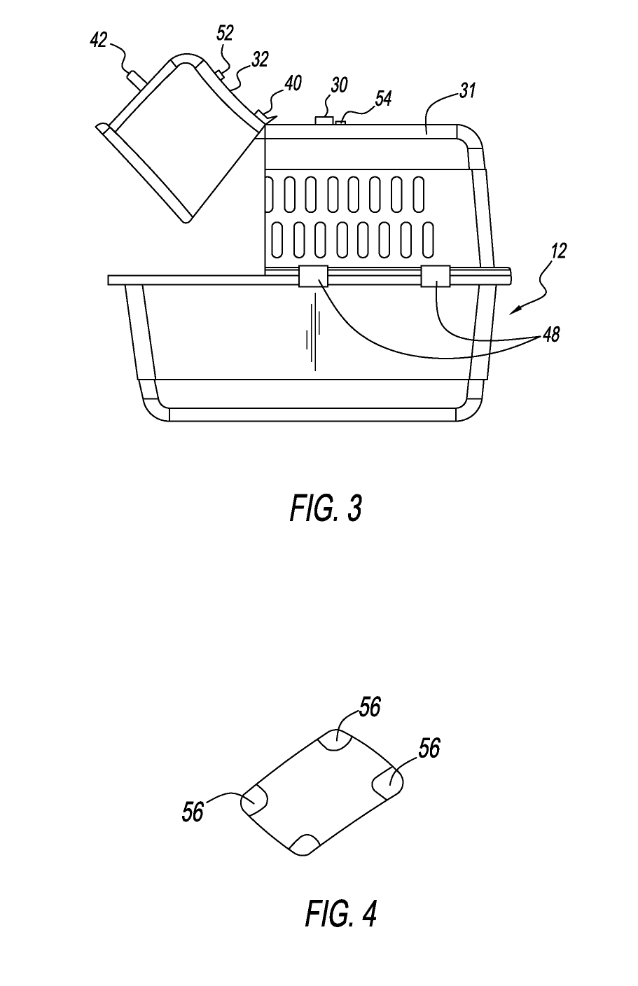

Referring to FIG. 3, there is shown a right side elevational view of the pet kennel 10 with the swinging front access section 32 partially open and the fixed section 31 locked to the lower compartment 12 by means of the swing or slide quick release catches 48. If desired, a magnet 52 can be located on and securely attached to the partial top of the swingable section 32 which contacts a magnet 54 on the partial top 34 of the fixed section 31 when the swingable section is fully open. The magnets are provided to releasably hold the swingable section open.

Referring to FIG. 4, there is shown a view of the bottom of the pet kennel with a pad 56 of rubber or any high friction material at each corner of the pet kennel. The pads are provided to prevent the pet kennel from sliding around, especially when trying to place a difficult or reluctant pet into the pet kennel through the open swinging front access section 32.

In an embodiment, two strips of a high friction material such as rubber where each strip is one quarter of an inch high and one quarter of an inch wide is attached to the bottom of the pet kennel (not shown). The strips of material may be located along the long side edges of the pet kennel or they may be placed in the form of an X.

When using the pet kennel, a pet owner can place a pet into the pet kennel by simply lifting up the swingable access section, placing the pet into the pet kennel, and then closing the swingable access section by rotating it down to its closed position. Thus, the pet owner can place a pet into the pet kennel without taking the pet kennel completely apart. The swingable access section avoids the need to take the kennel completely apart when placing a pet into the kennel or when taking a pet out of the kennel. To reattach a top section to a bottom section of a pet kennel is cumbersome, takes a bit of time, and can be frustrating as realignment of the top section with the bottom section and operating the quick release catches is not as easy and simple as it seems.

Another feature of the pet kennel here disclosed is the owner's accessibility to his/her pet while traveling. By simply lifting up the swingable access section of the kennel a pet owner can comfort his/her pet easily in a car without opening a door on the kennel or unlocking and removing the top half of the kennel

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pet kennel comprising:
a lower compartment having a bottom, a rear wall, a front wall and two side walls;
an upper compartment having a fixed section and a swingable section;
wherein the fixed section of the upper compartment is removably attached to the lower compartment, and the swingable section is removably attached to the lower compartment and swingably attached to the fixed section;
wherein access to the pet kennel is provided when the swingable section is swung to an open position.

2. The pet kennel of claim 1 wherein the swingable section of the upper compartment is permanently attached to the fixed section of the upper compartment.

3. The pet kennel of claim 1 wherein the swingable section of the upper compartment is attached to the fixed section of the upper compartment with at least one hinge.

4. The pet kennel of claim 1 wherein the fixed section of the upper compartment has a partial top, partial side walls and a rear wall; and the swingable section of the upper compartment has a partial top, partial side walls and a front wall;
wherein the fixed section and the swingable section form the upper compartment.

5. The pet kennel of claim 4 wherein a carrying handle is attached to the partial top of the upper compartment for carrying the pat kennel.

6. The pet kennel of claim 4 wherein a handle is attached to the front wall of the swingable section for opening or closing the swingable section of the pat kennel.

7. The pet kennel of claim 6 wherein access into the pet kennel is through the open swingable section.

8. The pet kennel of claim 1 wherein the fixed section of the upper compartment is removably attached to the lower compartment with swing or slide quick release catches.

9. The pet kennel of claim 8 wherein the swingable section of the upper compartment is removably attached to the lower compartment with swing or slide quick release catches.

10. The pet kennel of claim 1 wherein the lower compartment and upper compartment are composed of a rigid or semi rigid plastic.

11. The pet kennel of claim 10 wherein the lower compartment and upper compartment are composed of PVC.

12. The pet kennel of claim 1 wherein a member having a coefficient of friction that is greater than that of the bottom of the lower compartment is attached to the bottom of the lower compartment.

13. The pet kennel of claim 12 wherein the member is rubber.

14. The pet kennel of claim 12 wherein the member is a pad of rubber located at each corner of the bottom.

15. The pet kennel of claim 12 wherein the member is at least a strip of rubber attached to the bottom.

16. The pet kennel of claim 4 wherein the side walls and the rear wall of the fixed section of the upper compartment have vent openings for air to enter and leave the pet kennel.

17. The pet kennel of claim 5 wherein the carrying handle can be folded down into a recess.

18. The pet kennel of claim 6 wherein the handle can be folded down into a recess.

19. The pet kennel of claim 4 wherein a magnet is attached to the partial top of the fixed section of the upper compartment to contact a magnet on the front wall of the swingable section of the upper compartment when open to hold the swingable section open.
